(19) United States
(12) Patent Application Publication
(10) Pub. No.: US 2008/0192843 A1
(43) Pub. Date: Aug. 14, 2008

(54) Video channel estimation

(76) Inventors: Roy Tenny, Ramat Hasharon (IL); Roy Oren, Magshimim (IL); Tzahi Oren, Kfar Saba (IL)

Correspondence Address: EMPK & Shiloh, LLP, 116 JOHN ST,, SUITE 1201, NEW YORK, NY, 10038, US

(21) Appl. No.: 11/704,936

(22) Filed: Feb. 12, 2007

(51) Int. Cl. H04L 27/28; H04N 5/44

(52) U.S. Cl. 375/260; 348/725; 348/E09.001

(57) ABSTRACT

There is provided herein a method of estimating a channel impulse response, the method includes using an incomplete set of orthogonal frequency division multiplexing (OFDM) symbols to estimate said impulse response. There is further provided a devise and a system which includes a device for digital video channel estimation, the devise includes a channel estimation circuitry adapted to estimate a channel impulse response using an incomplete set of orthogonal frequency division multiplexing (OFDM) symbols to estimate said impulse response.

### FIELD OF THE DISCLOSURE

The present disclosure relates generally to the field of orthogonal frequency division multiplexing (hereinafter referred to as OFDM) modems. More specifically, the present disclosure relates to a method for improving the performance of a video handheld receiver incorporating an OFDM modem, and to a video handheld receiver incorporating an OFDM modem that utilizes the method.

### BACKGROUND

The capacity of digital multimedia applications/services rendered is growing rapidly, side by side with communication standards that are being continuously formulated to adapt services to handheld and other generally mobile and/or wireless service(s) rendering devices. One result of this trend is increasing demand for broadband telecommunication systems.

Broadband refers to a signalling method used in telecommunications in which a wide band of frequencies is used to transmit information by distributing the information over the band of frequencies. The band of frequencies is also referred to in telecommunications as channels or frequency bins. The terms “channels” or “frequency bins” may also be used interchangeably with “frequency cells” and “frequency carriers”. The wider the bandwidth, the more information can be carried. In the Public Switched Telephone Network (PSTN) a modem will typically communicate using a bandwidth of 64 kilobits per seconds (kbit/s) over the telephone line while over the same telephone line Asymetric Digital Subscriber Line, commonly referred to as ADSL,which is considered broadband, will communicate using a bandwidth of several megabits per second. By dividing the bandwith into frequency bins, broadband communication allows simultaneous transmission of pieces of data resulting in an increase in the effective rate of data transmission, regardless of actual data rate.

Bandwidth may be defined as the width, measured in hertz, of the frequency range of a signal varying in time, in which the signal's Fourier transform is nonzero. Generally speaking, when referring to the bandwidth of a system the meaning is that the system can process signals of that bandwidth. In digital communications bandwidth may refer to data rates, or the number of bits per unit of time, which may be transmitted over a communications channel or through the system. In some applications the term baud rate is used instead of bandwidth to describe the rate at which symbols, which consist of a group of bits, may be transmitted through the system.

Multiplexing is used in telecommunications to combine two or more data transmission channels into a single data transmission channel prior to transmission of the data through a communincation medium. When the data is received at the other end of the communication medium the inverse operation, typically referred to as demultiplexing, is performed so as to extract the original channels. Several basic forms of multiplexing include time-division multiplexing (TDM), frequency-division multiplexing (FDM), and code-division multiplexing (CDM), particularly used in digital communications. Each separate channel involved in the multiplexing process is considered to be of narrow bandwidth, or narrowband, whereas all the multiplexed channels together in a single channel may be described as broadband.

OFDM is an advanced communication method that allows for transmission and reception of high data rates using relatively low-complexity transmitting and receiving equipment, while providing high resistance to multi-path interference and noise. OFDM has been chosen as the transmission standard for the European radio digital audio broadcasting (DAB) and digital video broadcast terrestrial (DVB-T) standards. The OFDM methodology is described in many articles, for example, “Basics of Orthogonal Frequency Division Multiplexing (OFDM)” (by Greg DesBrisay,© 2000 Cisco Systems, Inc), incorporated herein by reference.

DVB-T is the DVB European consortium standard for the broadcast transmission of digital terrestrial television. It calls for the implementation of digital technology in television broadcasting which provides a greater number of channels and/or better quality of picture, such as that found in EDTV (Enhanced-definition television) and HDTV (High-definition television), and sound, for example Dolby Digital, through a conventional antenna instead of a satellite dish or cable connection. The system basically consists of the transmission of a compressed digital audio/video stream using OFDM, appropriately modulated (modified) and coded for transmission and subsequent reception by home set top boxes connected to the TV.

DVB-H is the DVB European consortium standard for the broadcast transmission of digital handheld television, adapting DVB-T system requirements fit those of handheld, battery-powered receivers. Similar to DVB-T, DVB-H basically consists of the transmission of a compressed digital audio/video stream using OFDM, appropriately modulated and coded for transmission and subsequent reception by the handheld receiver. IP (Internet Protocol) datagrams are transmitted at high data rates as data bursts in small time slots, the high power-consuming receiving portion of the receiver switching on only for the time interval when the data burst of a selected service is received. The data is stored in a buffer and, usually when all the data is received, played out in a TV screen incorporated in the handheld receiver in a live stream, also known as streaming media. The use of the buffer enables power saving in the use of the receiver, the amount dependent on the relation of the on/off time of the receiving portion of the receiver.

IP datagrams are formatted blocks of data, or packets, that conform to an internet protocol and are not transmitted reliably, so that acknowledgement of reception is not returned to the transmitter. A packet is generally formatted into three sections; a header marking the beginning of the packet, a data section containing the information which is being conveyed, and a trailer, marking the end of the packet.

Data blocks are generally transmitted in the form of symbols where each symbol in made up of individual bits, each bit representing a binary digit. Symbol rate, which is measured in symbols-per-second, is the bit rate divided by the number of bits making up each symbol, and is relevant in determining the system bandwidth for different modulation schemes.

In telecommunications it is common practice, for transmission purposes, to copy signals at low frequencies to high frequencies to avoid signal distortion typically associated with low frequency communication channels. The low frequencies are generally referred to as baseband frequencies and the signal at baseband frequencies is referred to as a baseband signal, while the high frequencies are generally RF (radio frequency) and the signal referred to as a RF signal. The process of shifting the baseband signal to a RF signal is referred to as modulation.

Modulation is technique applied in order to modify a carrier signal used to convey information so as to facilitate the transmission of the carrier signal through a communication channel. The result of a modulation process is a modulated signal, wherein the amplitude, phase and frequency may have been modified in accordance with an information signal to obtain the modulated signal. Modulation of a carrier signal is performed using a modulator and the inverse operation to recover the original signal, the process known as demodulation, is performed with a demodulator. A device that can do both operations is referred to as a modem.

In digital modulation, a list known as a modulation alphabet is used to represent the symbols originally transmitted in the modulated signal. This modulation alphabet, typically implemented in the demodulator, may be represented on a constellation diagram as a representation of a digital modulation scheme in the complex plane. The complex plane consists of a real and an imaginary axis which are commonly referred to as the “in phase” or I-axis and the “quadrature” or Q-axis. The modulation symbols which comprise the modulation alphabet are plotted on the constellation diagram. Upon reception of a modulated signal, the demodulator examines the received symbol, which may have been corrupted by channel distortion and noise, and selects as its estimate of what was actually transmitted that point on the constellation diagram which is closest to that of the received signal. This process is called maximum likelihood detection and enables the demodulator to reconstruct at the receiver the original symbols transmitted. If noise and distortion affect the received signal so that the symbols finish closer to another constellation point than the one transmitted, the signal is incorrectly demodulated and the wrong information transferred.

QAM (quadrature amplitude modulation) is a modulation scheme for transmitting data by changing the amplitude of two carrier waves, a carrier wave being a waveform that is modulated to represent the information to be transmitted. These two waves, usually sinusoids, are out of phase with each other by 90° and are thus called quadrature carriers. In QAM, the two carrier waves are combined to form a single channel, thereby doubling the effective bandwidth. One of the two carrier waves is called the I signal (the in-phase wave) and the other is called the Q signal (the out-of-phase wave) Mathematically, one of the signals can be represented by a sine wave, and the other by a cosine wave. The two modulated carriers are combined at the source (transmitter) for transmission. At the destination (receiver), the two carrier waves are separated, the data is extracted from each carrier wave and then the data is combined to obtain the original modulating information.

PSK (phase-shift keying) is a method of digital communication in which the phase of a transmitted signal is varied to convey information. There are several methods that can be used to accomplish PSK. The simplest PSK technique is called binary phase-shift keying (BPSK), and it uses two opposite signal phases (0 and 180 degrees). The digital signal is broken up time-wise into individual bits (binary digits). The state of each bit is determined according to the state of the preceding bit. If the phase of the wave does not change, then the signal state stays the same (0 or 1). If the phase of the wave changes by 180 degrees; that is, if the phase reverses, then the signal state changes (from 0 to 1 or from 1 to 0).

Multiple phase-shift-keying (MPSK) is a more sophisticated form of PSK. In MPSK there are more than two phases, usually four (0, +90, −90, and 180 degrees) or eight (0, +45, −45, +90, −90, +135, −135, and 180 degrees). If there are four phases (m=4), the MPSK mode is called quadrature phase-shift keying or quaternary phase-shift keying (QPSK), and each phase shift represents two signal elements. If there are eight phases (m=8), the MPSK mode is known as octal phase-shift keying (OPSK), and each phase shift represents three signal elements. In MPSK, data can be transmitted at a faster rate, relative to the number of phase changes per unit time, than is the case in BPSK.

OFDM is a modulation scheme for transmission where each frequency channel carries a separate stream of data. In OFDM the frequencies are chosen so that the modulated data streams are orthogonal to each other, such that the baseband signal is the sum of a number of orthogonal sub-carriers, with data on each sub-carrier being independently modulated by using some type of QAM or PSK. The modulation rate, which is the rate at which a carrier is varied to represent the information in a digital signal, is low so that the length of the symbol will be long compared to the channel time characteristics. These modulated symbols on each of the sub-carriers are then sent in parallel.

OFDM sub-carriers usually have a common precisely chosen, frequency spacing. This is the inverse of the duration referred to as the active symbol period, during which period a receiver extracts and examines the data or information (referred to herein interchangeably) contained within the signal. In many other types of modulation schemes, where a signal simultaneously conveys different data elements, a filter has to be used by the receiver for discriminating between the different data elements. However, in OFDM, the way the sub-carriers are spaced ensures the orthogonality of the sub-carriers, such that the demodulator for one sub-carrier does not recognize, or is not affected, by the modulation of the other sub-carriers. The result is that there is no effective interference between the sub-carriers limiting noise interference between channels.

A communication channel is the medium through which a signal flows from a transmitter to a receiver. Channel distortions are types of distortions affecting a signal transmitted from a transmitter to a receiver and are caused by the properties of the channel through which the signal is propagating. Channel fading, also referred to as “fading channel”, are distortions (or variations) in the propagation channel properties and can be classified as two types; those occurring in a linear time invariant (LTI) channel and those occurring in a time varying channel.

Channel fading in a LTI channel is associated with the signal arriving at the receiver after being reflected from stationary objects, for example, buildings and mountains, and is commonly referred to as multipath interference. The signal at the receiver can be the superposition of several received signals, each which has traveled through a different path, and therefore each has its own attenuation, phase and delay. The time delay spread is then the maximum difference of the individual time delays of the propagation paths followed by the signal from the transmitter to the receiver. There are two types of channel fading based on time delay spread; flat fading, where the bandwidth of the signal is less than the coherence bandwidth of the channel (time delay spread is significantly less than the symbol period), and frequency selective fading, where the bandwidth of the signal is greater than the coherence bandwidth of the channel (time delay spread is not significantly smaller than the symbol period).

Doppler shift is the apparent change in frequency and wavelength of a wave as perceived by an observer moving relative to the source of the waves. This may be due to the motion of the wave source, the observer or both the wave source and the observer.

Channel fading in time varying channels is associated with mobile transmissions standards, such as DVB-H, wherein the channel through which the signal propagates from transmitter to receiver can encounter rapid variations in time. These variations can be caused by several factors such as the movement of the transmitter and/or receiver, and/or moving objects which are part of the propagation path and which are of a reflecting or occluding nature. These movements can result in changes in the properties of the communication channel such as time delays, attenuations, and Doppler shifts of the propagation paths. There are two types of fading based on Doppler spread; fast fading, which has a high Doppler spread where the channel variations are not significantly slower than baseband signal variations (the coherence time is less than the symbol period), and slow fading, which has a low Doppler spread so that the channel variations are significantly slower than the baseband signal variations (the coherence time is greater than the symbol period).

Intersymbol interference (ISI) is a state wherein channel fading results in the temporal spreading and the eventual overlapping of different symbols such that the received signal cannot be interpreted by the receiver. Typically, channel variations in time are assumed to be slow variations such that the properties of the communication channel remains constant during the transmission period of a single OFDM symbol. Nevertheless, there may be occasions wherein, depending on the severity and nature of the time delays in the propagation paths of the signal, successively transmitted symbols may reach a receiver at substantially the same time. This phenomenon, referred to as ISI, causes different symbols to partially or wholly overlap at the receiver, subsequently resulting in fading or even cancellation of the received signal.

Guard intervals are used in telecommunications to ensure that distinct transmissions do not interfere with one another. To reduce the effect of ISI, a guard interval is traditionally added, or appended, to each symbol in a way that each symbol is transmitted for a total symbol period that is longer than the active symbol period by a period called the guard interval or cyclic prefix (CP), referred to herein interchangeably. A combination of a symbol and the cyclic prefix appended to it is referred to herein as an extended symbol. The traditional purpose of the guard interval is to introduce immunity to echoes and reflections while using OFDM coding since digital data is normally very sensitive to echoes and reflections. As long as the echoes and reflections fall within the guard interval they will not affect the receiver's ability to safely decode the actual data, as data is only interpreted outside the guard interval. The longer the guard interval the more distant echoes and reflections can be tolerated. However, the longer the guard interval is relative to the useful data transmission the more data capacity per time unit is lost.

The CP is a copy of the last portion of the symbol appended to the front of the symbol during the guard interval. The CP ensures that delayed data replicas will include the same information as non-delayed data. In addition, the CP facilitates realigning of data portions at the receiver and, thus, regaining orthogonality. The cyclic prefix is sized appropriately to serve as a guard time to eliminate ISI, generally chosen to be larger than the largest expected time delay spread of the communication channel. Nevertheless, this forces a tradeoff between the amount of time delay spread that is acceptable and the amount of Doppler spread that is acceptable.

Channel estimation is the process by which the effect a channel has on transmitted data is estimated for received data so as to reconstruct, to the maximum extent possible, the original transmitted data at the receiver. Channel estimation is required in order to remove ISI and other types of channel variations associated with channel fading. Channel estimation is based on mathematical modeling of the channel characteristics and the subsequent integration into a receiver of the necessary functions.

In order to enable channel estimation in the presence of fading channel, some standards, such as DVB-T and DVB-H, require the use of a frequency carrier with known reference data incorporated into the carrier. The reference data are known as pilot symbols (hereinafter referred to as pilots), their structure in DVB-H described by ETSI (European Telecommunications Standards Institute) Standards ETSI EN 302 304 V1.1.1 (2004-11), “Digital Video Broadcasting (DVB); Transmission System for Handheld Terminals (DVB-H)”, ETSI TR 102 377 V1.2.1 (2005-11), “Digital Video Broadcasting (DVB);DVB-H Implementation Guidelines”, and ETSI EN 300 744 V1.5.1 (2004-06), “Digital Video Broadcasting (DVB); Framing Structure, Channel Coding and Modulation for Digital Terrestrial Television”, the disclosures incorporated herein by reference. The pilots may include continuous pilots and scattered pilots. Continuous Pilots are pilots transmitted in the same set of frequency carriers, for all OFDM symbols. Scattered Pilots (hereinafter used interchangeably with pilots), on the other hand, are transmitted in different frequency locations during different OFDM symbols.

Frequency location is a descriptor of the location in the frequency domain of a pilot, a data carrier or other type of carrier. For example, a frequency location may be an index describing the location of the pilot in the frequency domain (for example a pilot located in the fifth frequency bin, or fifth frequency cell). Alternatively, a frequency location may be the frequency of a pilot, a data carrier or other type of carrier. For example, the pilot located at 117 MHz. A full set of frequency locations is a set of all frequency locations which contain a scattered pilot at least once during transmission of all the OFDM symbols. For example, in FIG. 4 below, a full set of frequency locations is the set of frequency bins described by the indexes k₁=0, 3, 6, 9, . . . .

A method for channel estimation using pilots is described in, H. Schober, F. Jondral, R. A. Stirling-Gallacher, Z. Wang, “Adaptive channel estimation for OFDM based high speed mobile communication system”, Proc. IEEE Int. Conf. Third Generation Wireless and Beyond, 2001, pp. 392-397, the disclosure incorporated herein by reference.

Channel estimation using pilots is performed based on a comparison of the characteristics of the transmitted pilots and the characteristics of the same pilots received at the receiver so as to model a channel transfer function. The basic process involves determining the channel frequency impulse response for the pilots and, based on this information and through an interpolation process, determining the channel impulse response for the rest of the transmitted data. The term channel impulse response and channel response may be used interchangeably hereinafter. However, in order to adequately interpolate the channel impulse response for carriers which do not contain pilots by using the channel impulse response for the pilots, the spacing between the pilots in each OFDM symbol can not be too large, and the maximum spacing between pilots can be determined by using the Nyquist-Shannon sampling theorem.

Sampling is the process of converting a signal into a numeric sequence by sampling the value of the signal at discrete intervals. The Nyquist-Shannon sampling theorem (hereinafter referred to as the Nyquist Theorem) states that exact reconstruction of a continuous-time baseband signal from its samples is possible if the signal is bandlimited and the sampling frequency is greater than twice the signal bandwidth. A signal is bandlimited if it contains relatively no energy at frequencies higher than the bandwidth. General background about sampling, interpolations, replicas, and the Nyquist sampling theorem can be found in “Signals and Systems” Alan V. Oppenheim and Alan S. Willsky, Second Edition, Prentice-Hall 1997 incorporated herein by reverence, and in “Digital Signal Processing”, John G. Proakis, and Dimitris G. Manolakis, Prentice Hall, Third Edition, 1996, the disclosure incorporated herein by reference.

A signal may be represented in the time domain by sequentially sampling signal levels at consecutive time instances. A signal may also be represented in the frequency domain by applying the Discrete Fourier Dransform (DFT) or Fast Fourier Transform (FFT) on the signal's representation in the time domain. The signal's representation in time domain may be obtained from the signal's representation in the frequency domain by applying the Inverse Discrete Fourier Transform (IDFT) or Inverse Fast Fourier Transform (IFFT) on the signal's representation in the frequency domain.

Channel impulse response may be represented in the time domain, referred to as the channel impulse response in the time domain, or in the frequency domain, referred to as the channel impulse response in the frequency domain. Channel impulse response in the time domain may be referred to hereinafter as time response. Channel impulse in the frequency domain may be referred to hereinafter as frequency response. It is possible to calculate the channel response in the frequency domain by applying the Fourier Transform on the channel impulse response in the time domain. It is possible to calculate the channel response in the time domain by applying the Inverse Fourier Transform on the channel impulse response in the frequency domain. All the above transformations are well known in the art of communication systems.

DVB-H and DVB-T standards require that scattered pilots be divided into 4 groups (also referred to as scattered pilots phases). A scattered pilots phase is a unique index applied to a set of OFDM symbols in which each OFDM symbol contains scattered pilots located in the same frequency locations as the scattered pilots in the other OFDM symbols in the set. The term “scattered pilots phase” may be used interchangeably hereinafter with “SP phase”. In each SP phase the pilots must be spaced 12 carriers apart. However, using the Nyquist theorem, the largest delay spread allowed by the DVB standard is equal to the guard time interval Tg, so that,

Tspread=T_{g}=Tsym/4

where Tspread=time delay spread, T_{g}=time duration of the guard interval, and Tsym is the time duration of each OFDM symbol without the cyclic prefix (CP).

Since the guard interval, Tg, can reach ¼ of the symbol interval, Tsym, then according to the Nyquist theorem the pilots should not be spaced more than 4 carriers apart in order to be able to reconstruct the channel impulse response which may have delay spread, Tspread, such that Tspread=Tg=Tsym/4. Since the pilots in a single OFDM symbol are spaced 12 carriers apart, they are not sufficient for channel reconstruction. This problem is commonly solved by generating a shift of 3 frequency bins between the pilots of consecutive symbols. Since each OFDM symbol contains pilots separated 12 carriers apart, then 4 consecutive OFDM symbols will contain pilots in locations separated 3 pilots apart. Using time interpolation which considers the pilots available from OFDM symbols other than the current OFDM symbol, the pilots are separated 3 bins apart instead of 12 bins apart, and therefore there is compliance with the Nyquist theorem requirement of carriers separated less than 4 frequency bins apart. Reconstruction of the channel with delay spread T_{g}=Tsym/4 is then possible.

Situations involving high Doppler frequencies are characterized by channel variations which are rapid, so that the channel impulse response during the current OFDM symbol may be significantly different than the channel impulse response during the time of receiving other OFDM symbols used to perform the time interpolations. As a consequence, the time interpolation is not accurate and there is degradation in the performance of the modem.

Two contradicting situations are encountered when performing channel estimation for time varying channels according to the DVB standards:

a. In channel with higher Doppler frequencies the channel impulse response varies more rapidly between consecutive OFDM symbols, and therefore, implementing time interpolation of OFDM symbols which are further apart in time from the current OFDM symbol results in less accurate time interpolation

b. In channel with a larger delay spread, such as Tspread=Tsym/4, then according to the Nyquist theorem, at least four different OFDM symbols with four different SP phases are used in order to obtain channel values at carriers spaced 3 frequency bins. The requirement to use at least four OFDM symbols, contradicts the requirement to use OFDM symbols which are as close as possible to each other. Therefore, the time interval between OFDM symbols used for time interpolation will result in degradation in the accuracy of the time interpolation.

The foregoing examples of the related art and limitations related therewith are intended to be illustrative and not exclusive. Other limitations of the related art will become apparent to those of skill of the art upon a reading of the specification and a study of the figures.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other advantages or improvements.

In accordance with some embodiments a method for estimating channel impulse response is provided which includes using an incomplete set of received orthogonal frequency division multiplexing (OFDM) symbols to estimate the impulse response.

In accordance with other embodiments a method for estimating channel impulse response is provided which includes using an incomplete set from a full set of OFDM symbols wherein at least one of the OFDM symbols comprises a scattered pilot. Each OFDM symbol within the full set of OFDM symbols is associated with an SP phase.

In accordance with some embodiments a method for estimating channel impulse response is provided which includes using an incomplete set from a full set of received OFDM symbols to estimate the impulse response. The method provides for estimating the channel impulse response using a full set of OFDM which includes 4 OFDM symbols. The methods also provides for estimating the channel impulse response using an incomplete set of OFDM symbols, such as 3 OFDM symbols, 2 OFDM symbols, and 1 OFDM symbol.

In accordance with some embodiments a method for estimating channel impulse response is provided which includes determining a first channel estimation value based on full set of received OFDM symbols and determining a second channel estimation based on the first channel estimation value, and on a second set of received OFDM symbols, wherein the second set of received OFDM symbols is an incomplete set of OFDM symbols. The method also provides for estimating channel impulse response using an incomplete set of the first of received OFDM symbols and a second set of received OFDM symbols, wherein the second set of received OFDM symbols is an incomplete set of OFDM symbols.

In accordance with other embodiments a method for estimating channel impulse response is provided which includes determining where the channel impulse response in the time domain occupies a portion of the allowed guard interval. Identification of at least one region of relatively distinct energy level within the channel impulse response in the time domain may be required.

In accordance with some embodiments a method for estimating channel impulse response is provided which includes estimating a channel impulse response using an incomplete set of scattered pilots. The method provided may include eliminating time domain replicas in channel estimation caused partially or fully due to the use of the incomplete set of scattered pilots instead of a full set of scattered pilots. Locations of replicas and the original channel impulse response in the time domain may be determined by using at least one region of relatively distinct energy. Eliminating the time domain replicas may be performed in the frequency domain by convolving the channel impulse response in the frequency domain, which contains replicas in the time domain with a filter which attenuates the replicas relative to the correct channel impulse response. Eliminating time domain replicas may be performed in the time domain by multiplying the channel impulse response in the time domain, which contains replicas in the time domain, with a bandpass filter which attenuates the replicas relative to the correct channel impulse response. The filter may be determined partially or fully by using one region of relatively distinct energy.

In accordance with some embodiments a device for digital video channel estimation is provided which includes channel estimation circuitry adapted to estimate channel impulse response using an incomplete set from a full set of received OFDM symbols to estimate the impulse response.

In accordance with some embodiments a device for digital video channel estimation is provided which includes channel estimation circuitry adapted to estimate channel impulse response using an incomplete set from a full set of received OFDM symbols wherein at least one of the OFDM symbols comprises a scattered pilot. Each OFDM symbol within the full set of OFDM symbols is associated with a different SP phase.

In accordance with some embodiments a device for digital video channel estimation is provided which includes channel estimation circuitry adapted to estimate channel impulse response using an incomplete set from a full set of received OFDM symbols to estimate the impulse response. The device for digital video channel estimation provides for estimating the channel impulse response using a full set of OFDM which includes 4 OFDM symbols. In accordance with other embodiments the device for digital video channel estimation includes channel estimation circuitry adapted to estimate the channel impulse response using an incomplete set of OFDM symbols, such as 3 OFDM symbols. In some other embodiments the device for digital channel estimation includes channel estimation circuitry adapted to estimate the channel impulse response using 2 OFDM symbols in an incomplete set of OFDM symbols, while in other embodiments the device for digital channel estimation includes channel estimation circuitry further adapted to estimate the channel impulse response using 1 OFDM symbol in an incomplete set of OFDM symbols.

In accordance with some embodiments a device for digital video channel estimation is provided which includes channel estimation circuitry adapted to estimate channel impulse response by determining a first channel estimation value based on full set of received OFDM symbols and determining a second channel estimation based on the first channel estimation value, and on a second set of received OFDM symbols, wherein the second set of received OFDM symbols is an incomplete set of received OFDM symbols. In accordance with other embodiments the device for digital video channel estimation includes channel estimation circuitry further adapted to estimate channel impulse response by using an incomplete set of the first of received OFDM symbols and a second set of received OFDM symbols, wherein the second set of received OFDM symbols is an incomplete set of OFDM symbols.

In accordance with some embodiments a device for digital video channel estimation is provided which includes channel estimation circuitry adapted to estimate channel impulse response by determining where the channel impulse response in the time domain occupies a portion of the allowed guard interval. The device for digital video channel estimation includes channel estimation circuitry further adapted to identify at least one region of relatively distinct energy level within the channel impulse response in the time domain.

In accordance with other embodiments a device for digital video channel estimation is provided which includes channel estimation circuitry adapted to estimate channel impulse response using an incomplete set of scattered pilots. The device for digital channel estimation including the channel estimation circuitry may be adapted to eliminate time domain replicas in channel estimation caused partially or fully due to the use of the incomplete set of scattered pilots instead of a full set of scattered pilots. Locations of replicas and the original channel impulse response in the time domain may be determined by using at least one region of relatively distinct energy. Eliminating the time domain replicas may be performed in the frequency domain by convolving the channel impulse response in the frequency domain, which contains replicas in the time domain with a filter which attenuates the replicas relative to the correct channel impulse response. Eliminating time domain replicas may be performed in the time domain by multiplying the channel impulse response in the time domain, which contains replicas in the time domain, with a bandpass filter which attenuates the replicas relative to the correct channel impulse response. The filter may be determined partially or fully by using one region of relatively distinct energy.

In accordance with some embodiments a system for digital video receiving which includes a video display device and a device for digital video channel estimation is provided which includes channel estimation circuitry adapted to estimate channel impulse response using an incomplete set from a full set of received OFDM symbols to estimate the impulse response.

In accordance with some embodiments a system for digital video receiving which includes a video display device and a device for digital video channel estimation is provided which includes channel estimation circuitry adapted to estimate channel impulse response using an incomplete set from a full set of received OFDM symbols wherein at least one of the OFDM symbols comprises a scattered pilot. Each OFDM symbol within the full set of OFDM symbols is associated with a different SP phase.

In accordance with some embodiments a system for digital video receiving which includes a video display device and a device for digital video channel estimation is provided which includes channel estimation circuitry adapted to estimate channel impulse response using an incomplete set from a full set of received OFDM symbols to estimate the impulse response. The device for digital video channel estimation provides for estimating the channel impulse response using a full set of OFDM which includes 4 OFDM symbols. In accordance with other embodiments the system includes a device for digital video channel estimation which includes channel estimation circuitry adapted to estimate the channel impulse response using an incomplete set of OFDM symbols, such as 3 OFDM symbols. In some other embodiments the system includes a device for digital channel estimation which includes channel estimation circuitry adapted to estimate the channel impulse response using 2 OFDM symbols in an incomplete set of OFDM symbols, while in other embodiments the system includes a device for digital channel estimation which includes channel estimation circuitry further adapted to estimate the channel impulse response using 1 OFDM symbol in an incomplete set of OFDM symbols.

In accordance with some embodiments a system for digital video receiving which includes a video display device and a device for digital video channel estimation is provided which includes channel estimation circuitry adapted to estimate channel impulse response by determining a first channel estimation value based on full set of received OFDM symbols and determining a second channel estimation based on the first channel estimation value, and on a second set of received OFDM symbols, wherein the second set of received OFDM symbols is an incomplete set of received OFDM symbols. In accordance with other embodiments the system includes a device for digital video channel estimation which includes channel estimation circuitry further adapted to estimate channel impulse response by using an incomplete set of the first of received OFDM symbols and a second set of received OFDM symbols, wherein the second set of received OFDM symbols is an incomplete set of OFDM symbols.

In accordance with some embodiments a system for digital video receiving which includes a video display device and a device for digital video channel estimation is provided which includes channel estimation circuitry adapted to estimate channel impulse response by determining where the channel impulse response in the time domain occupies a portion of the allowed guard interval. The system includes a device for digital video channel estimation which includes channel estimation circuitry further adapted to identify at least one region of relatively distinct energy level within the channel impulse response in the time domain.

In accordance with other embodiments a system for digital video receiving which includes a video display device and a device for digital video channel estimation is provided which includes channel estimation circuitry adapted to estimate channel impulse response using an incomplete set of scattered pilots. The system includes a device for digital channel estimation which includes channel estimation circuitry which may be adapted to eliminate time domain replicas in channel estimation caused partially or fully due to the use of the incomplete set of scattered pilots instead of a full set of scattered pilots. Locations of replicas and the original channel impulse response in the time domain may be determined by using at least one region of relatively distinct energy. Eliminating the time domain replicas may be performed in the frequency domain by convolving the channel impulse response in the frequency domain, which contains replicas in the time domain with a filter which attenuates the replicas relative to the correct channel impulse response. Eliminating time domain replicas may be performed in the time domain by multiplying the channel impulse response in the time domain, which contains replicas in the time domain, with a bandpass filter which attenuates the replicas relative to the correct channel impulse response. The filter may be determined partially or fully by using one region of relatively distinct energy.

In addition to the exemplary aspects and embodiments described above, further aspects and embodiments will become apparent by reference to the figures and by study of the following detailed descriptions.

### BRIEF DESCRIPTION OF THE DRAWING

Exemplary embodiments are illustrated in referenced figures and drawings. It is intended that the embodiments and figures disclosed herein are to be considered illustrative rather than restrictive.

FIG. 1 shows an exemplary simplified functional block diagram of a transmitter in a typical configuration for the generation of an OFDM symbol \tilde{x}(n₁,n₂), and a transmission channel through which \tilde{x}(n₁,n₂) is propagated, currently known in the art;

FIG. 2 illustrates an exemplary scattered pilots grid representing a pilots structure as required by the DVB standards and currently used in the art;

FIG. 3 is an exemplary simplified flow chart showing a method currently used in the art for channel estimation;

FIG. 4 is an exemplary scattered pilots grid currently used in the art representing a pilots structure;

FIG. 5 is an exemplary scattered pilots grid currently used in the art representing a pilots structure after time;

FIG. 6 is an exemplary scattered pilots grid currently used in the art representing a pilots structure after frequency interpolation;

FIG. 7A is an exemplary illustration of a channel impulse response in a fully occupied guard interval for an embodiment of the present disclosure;

FIG. 7B is an exemplary illustration of a channel impulse response in a partially occupied guard interval for an embodiment of the present disclosure;

FIG. 7C is an exemplary illustration of a channel impulse response in a partially occupied guard interval for another embodiment of the present disclosure;

FIG. 8 is an exemplary simplified flow chart showing the steps of an algorithm which may be used to reconstruct a channel impulse response H(k₁,n₂), based on the use of incomplete sets of scattered pilots;

FIG. 9 shows exemplary graphs of channel impulse response in the time domain of the implementation of the system and the method described by an embodiment of the present disclosure;

FIG. 10 shows exemplary pilot grids in the frequency domain of the implementation of the system and the method described by an embodiment of the present disclosure;

FIG. 11 shows an exemplary simplified functional block diagram of an embodiment of this disclosure which includes a receiver for the implementation of the system and method described by the present disclosure.

FIG. 12 schematically shows an exemplary conceptual block diagram of a system including a receiver and a video display device, in accordance with an embodiment of the present disclosure.

### DETAILED DESCRIPTION

This disclosure relates to the use of Orthogonal Frequency Division Multiplexing (OFDM) modulation in DVB-H, and the advantages of using OFDM modulation through the efficient use of available spectrum and the convenient handling of fading channels, including delay spread and Doppler shifts. Furthermore, this disclosure relates to a system and to a method for DVB-H pilots-aided channel estimation by using a reduced sampling rate in the frequency domain and an incomplete set of scattered pilots. The terms incomplete set of scattered pilots, incomplete set of pilots, and incomplete set of the union of pilots available in a full set of symbols, may all be used interchangeably hereinafter.

An OFDM symbol, \tilde{x}((n), may be generated by modulating a data sequence according to the following formula:

$$x ( n ) = IFFT ( X ( k ) ) = \frac{1}{2 π} {\sum }_{k = 0}^{N - 1} X ( k ) \cdot {e}^{j \frac{2 π}{N} kn}$$

$$\tilde{x} ( n ) = \{ \begin{matrix}x ( n - g + N ) & n \leq g \\ x ( n - g ) & n > g\end{matrix}$$

where:
x(n)—OFDM symbol before applying the cyclic prefix.
\tilde{x}(n)—OFDM symbol transmitted at time n, including cyclic prefix guard interval.
g—time length of cyclic prefix guard interval.
X(k)—transmitted signal before conversion to OFDM symbol.
N—number of time samples comprising each OFDM symbol in the time domain before adding a cyclic prefix. N is also the number of frequency bins representing each OFDM symbol in the frequency domain.

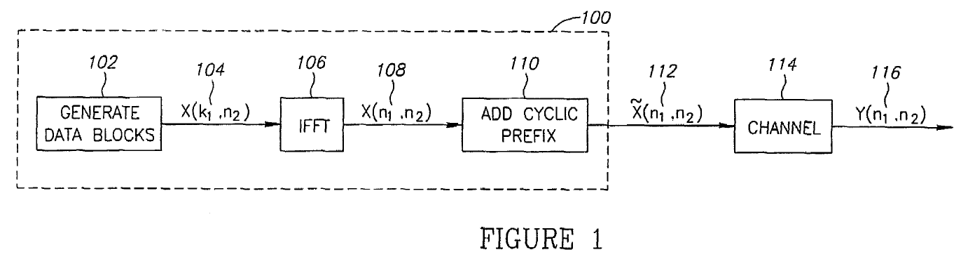

Reference is made to FIG. 1 which shows an exemplary simplified functional block diagram of a transmitter (100) in a typical configuration for the generation of an OFDM symbol \tilde{x}(n₁,n₂) (112), currently known in the art. Transmitter (100) may also be used in an embodiment of this disclosure. Hereinafter, the time index n₁ refers to a time index within an OFDM symbol, while the time index n₂ refers to a sequential time index of the entire symbol. For example, n₁=3 and n₂=5 means the third sample within the fifth OFDM symbol. Also, the frequency bin index k₁ refers to a frequency bin index within an OFDM symbol. For example, k₁=2 and n₂=4 means the second frequency bin within the fourth OFDM symbol.

The transmitter (100) includes a data source (102). Data source (102) maps the input stream into data sequence blocks of length N, also referred to as symbol data X(k₁,n₂)(104)

The symbol data X(k₁,n₂) (104) is input to an Inverse Fast Fourier Transform (IFFT) (106), resulting in a modulated symbol, x(n₁,n₂) (108), which is in the time domain. The modulated symbol, x(n₁,n₂) (108) is fed into a cyclic prefix generator (110). In the cyclic prefix generator (110) the guard interval is padded to x(n₁,n₂) (108) by copying the last g samples of x(n₁,n₂) (108) and padding those g samples to the beginning of x(n₁,n₂) (108). The resulting OFDM symbol \tilde{x}(n₁,n₂) (112), consisting of the modulated symbol, x(n₁,n₂) (108) with a cyclic prefix added to it, is then transmitted through the channel (114).

The transmission channel (114), through which the signal transmitted from the transmitter propagates to the receiver, may be modeled as a time invariant channel, or a time varying channel. The OFDM symbol \tilde{x}(n₁,n₁) (112) is transmitted into the channel (114) where it may be exposed to channel distortions. As a result, the OFDM symbol \tilde{x}(n₁,n₂) (112) originally transmitted at one end of the channel (114) may be substantially different from an OFDM symbol y(n₁,n₂) (116) which is received at the other end of the channel (114) by a receiver (not shown).

In an embodiment of this disclosure the channel may be a Linear Time variant channel. In this embodiment the received signal, y(n₁,n₂) may be given as a function of the transmitted signal, x(n₁,n₂) using the following model:

$$y ( {n}_{1} , {n}_{2} ) = {\sum }_{n = 0}^{N - 1} h ( n , {n}_{2} ) \cdot x ( {n}_{1} - n , {n}_{2} )$$

where:
n₁—time index of sample within OFDM symbol;
n2—time index of an entire OFDM symbol;
x(n₁,n₂)—the n₁^{st} sample within the n₂^{nd} transmitted OFDM symbol;
y(n₁,n₂)—the n₁^{st} sample within the n₂^{nd} received OFDM symbol; and
h(n₁,n₂)—a complex number representing the attenuation and phase change caused to the signal which propagated from the transmitter to the receiver with propagation time delay n₁, during the transmission of the n₂^{nd} OFDM symbol.

The sequence h(n_{1.}n₂ ) may be referred to as the channel impulse response in the time domain. The time index, n₂, is the time index of each OFDM symbol. If the channel varies in time, then the channel response, h(n₁,n₂), will vary with the time index n₂, and different OFDM symbols with different values of n₂ will experience different channel coefficients, h(n₁,n₂). If on the other hand, the channel impulse response does not vary in time, then all OFDM symbols will experience a channel model with the same coefficients h(n₁,n₂), and the channel impulse response h(n₁,n₂) will be independent of the OFDM symbol index n₂, and the index n₂ can then be omitted from the equations, so that h(n₁,n₂)=h(n₁).

The time varying channel impulse response in the frequency domain may then be modeled as:

$$H ( {k}_{1} , {n}_{2} ) = FFT ( h ( {n}_{1} , {n}_{2} ) ) = {\sum }_{n 1 = 0}^{N - 1} h ( {n}_{1} , {n}_{2} ) \cdot {e}^{- j \frac{2 π}{N} {k}_{1} {n}_{1}}$$

The transmitted signal in the frequency domain may be estimated by using

$$\hat{X} ( {k}_{1} , {n}_{2} ) = \frac{Y ( {k}_{1} , {n}_{2} )}{H ( {k}_{1} , {n}_{2} )}$$

Typically, channel variations in time, represented by time index n₂, may be slow variations, such that an assumption may be made that the channel impulse response, H, remains substantially constant during the transmission period of a single OFDM symbol, however in cases where this assumption does not hold, Inter Carrier Interference (ICI) may further distort the transmitted signal.

Without limiting to the generality of this disclosure, the time index n₂ will hereinafter represent the time index of each OFDM symbol, and the time index n₁ will represent the time index of a sample within an OFDM symbol. For example, y(n₁,n₂) represents the n₁ received sample within the n₂ received OFDM symbol, and the complex value Y(k₁,n₂) represents the amplitude and phase of the received signal at frequency bin k₁ within an OFDM symbol received at time index n₂.

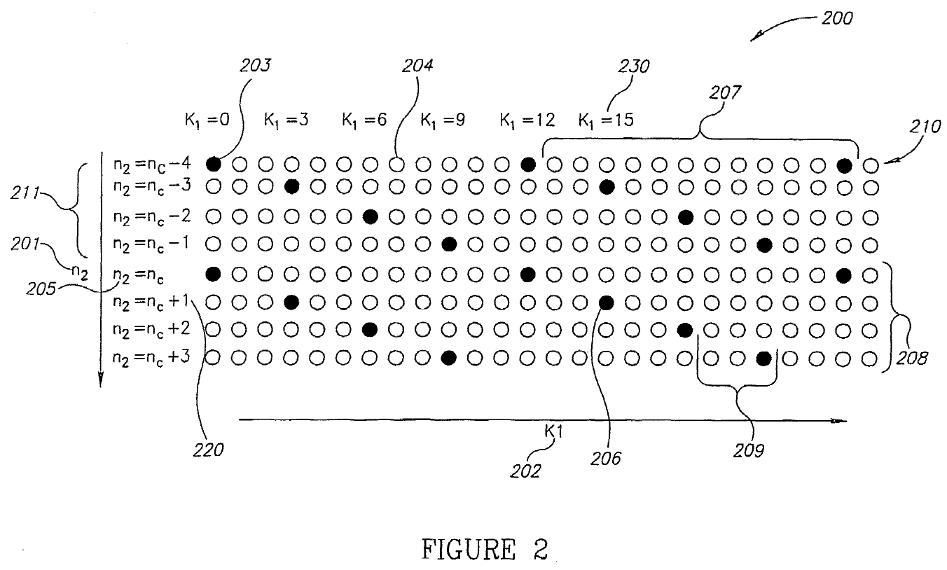

Reference is made to FIG. 2 which illustrates an exemplary scattered pilots grid (200) representing a pilots structure as required by the DVB standard and currently used in the art. The exemplary scattered pilots grid (200) may be used in some embodiments of the present disclosure. The horizontal axis k₁ (202), represents the frequency bin index of an ODFM symbol, and the vertical axis n₂ (201) represents the time index of an OFDM symbol. The time index, n₂=n_{c} (205) is the time index of the current symbol being estimated. Each circle in the figure represents a carrier within an OFDM symbol, wherein the frequency bin index and the OFDM symbol time index are given by k₁ and n₂ respectively. Carriers containing scattered pilots, for example the scattered pilot (203), are represented by black circles. The empty white circles represent data carriers, for example the data carrier (204), although they may also represent other types of carriers such as, continuous pilots or modem parameters data. In the exemplary scattered pilots grid (200), for the OFDM symbol being estimated at n₂=n_{c}+1 (220) the OFDM symbol contains a scattered pilot (206) at frequency bin k₁=15 (230).

The scattered pilots are divided into 4 groups, also referred to as 4 SP phases, for example the four SP phases (208). In each SP phase, for example the SP phase (210), the scattered pilots are spaced 12 carriers apart (207). The scattered pilots of one SP phase are shifted by three frequency bins relative to the next SP phase found in the next OFDM symbol, for example as shown in the three frequency bins (209). Each OFDM symbol contains scattered pilots from one SP phase only. For example, the OFDM symbol received at time index n₂=n_{c} (205) contains scattered pilots from SP phase 1, which are located at frequency bins k₁=0, 12, 24 . . . . The next symbol, received at time index n₂=n_{c}+1 (220) contains scattered pilots of SP phase 2 located at frequency bins k₁=3, 15, 27 . . . . The next symbol, received at time index n₂=n_{c}+2 contains scattered pilots of SP phase 3 located at frequency bins k₁=6, 18, 30 . . . . The next symbol, received at time index n₂=n_{c}+3 contains scattered pilots of SP phase 4 located at frequency bins k₁=9, 21, 33 . . . . These four OFDM symbols cover the four SP phases into which are divided the scattered pilots. Then, the SP phase sequence is repeated so that the next symbol received at time index n₂=n_{c}+4 contains scattered pilots of SP 1, the symbol, received at time index n₂=n_{c}+5 contains scattered pilots of SP phase 2, the symbol, received at time index n₂=n_{c}+6 contains scattered pilots of SP phase 3, and the symbol, received at time index n₂=n_{c}+7 contains scattered pilots of SP phase 4. This four SP phase sequence is repeated until all the OFDM symbols have been received.

Although each OFDM symbol contains scattered pilots from one SP phase only, and the scattered pilots within each OFDM symbol are separated 12 frequency bins apart, the union of the scattered pilots found in a group of symbols which contains all 4 SP phases provides a set of pilots separated 3 frequency bins apart, such that k₁=0, 3, 6, 9, 12, . . . . A set of scattered pilots which occupies each frequency location in a full set of frequency locations with at least one scattered pilot from the set may be referred to as a full set of scattered pilots. A set of scattered pilots which is not a full set of scattered pilots may be referred to as an incomplete set of scattered pilots. A set of symbols which includes a full set of scattered pilots may be referred to as a full set of symbols, for example the full set of symbols represented by the four consecutive time indexes (211). In the example shown in FIG. 2, a full set of symbols may be 4 or more received OFDM symbols, containing at least one from each of the four SP phases of scattered pilots. The union of scattered pilots found in a full set of symbols is separated 3 bins apart, for example the three frequency bins (209). A set of symbols which is not a full set of symbols may be referred to as an incomplete set of symbols. The terms “full set of symbols” and “full set of OFDM symbols” can be used interchangeably. Also, the terms “incomplete set of symbols” and “incomplete set of OFDM symbols” can be used interchangeably.

In order to reconstruct the transmitted data, estimation of the channel frequency impulse response H(k₁,n₂) in all the circles is performed. The estimation may be performed using the information contained by the scattered pilots since the transmitted pilots amplitude and phase are known, and the received signal at the frequencies of the transmitted carrier is known, then the channel at those frequencies may be estimated using:

$${\hat{H}}_{P} ( {k}_{1} , {n}_{2} ) = \frac{Y ( {k}_{1} , {n}_{2} )}{P ( {k}_{1} , {n}_{2} )}$$

where P(k₁,n₂) is the complex value representing the amplitude and phase of the scattered pilot at frequency bin k₁ (202) within the OFDM symbol received at time index n₂ (201).

This channel estimation is available only for the scattered pilots so that interpolation is required in order to reconstruct the channel in all circles, including the data carriers. In order to adequately interpolate the channel impulse response at time/frequency location of data carriers by using channel impulse response values at the locations of the pilots, the spacing between the scattered pilots in a group of OFDM symbols used for interpolation, represented by the horizontal spacing between black circles, may not be too large. The maximum spacing between pilots may be determined by using the Nyquist Theorem. The pilots provide sampling of the channel frequency impulse response at the time and frequency indexes of the pilots. According to the Nyquist Theorem, if the time delay spread of the channel impulse response in the time domain is contained within a time interval of duration Tg, then the spacing ΔKₘₐₓ in the frequency domain between pilots should not exceed

$$Δ {K}_{max} = \frac{Tsym}{Tg} = \frac{N * Tsamp}{g * Tsamp} = \frac{N}{g}$$

wherein Tsym is the symbol time length, Tg is the time length of the guard interval, N Tsamp is the time interval between consecutive samples in the time domain of the OFDM symbol, N is the number of samples in one OFDM symbol, and g is the number of samples in the guard interval.

For example, in DVB-H standards, the guard interval Tg can be as long as ¼ of the symbol duration Tsym. Using the Nyquist theorem, to be able to interpolate the value of the channel at data carriers the spacing in frequency domain between pilots should not exceed 4 frequency bins, since

$$Δ {K}_{max} = \frac{Tsym}{Tg} = \frac{4}{1} = 4$$

In this example, a single symbol in which the spacing between pilots is 12 frequency bins is not sufficient for interpolation since the spacing between pilots used for interpolation is larger than 4. However, in a full set of symbols the spacing in the frequency domain between pilots is 3 frequency bins, less than the maximum of four required when applying the Nyquist theorem. Therefore a full set of symbols can be used for estimating the channel at the locations of data carriers.

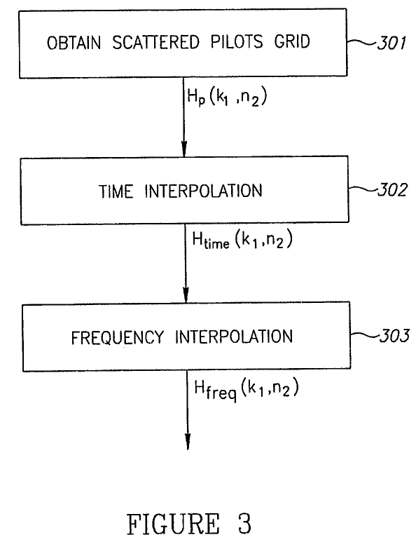

Reference is made to FIGS. 3, 4, 5 and 6 which illustrate an exemplary method used for channel estimation currently used in the art. The exemplary method used for channel estimation may also be used in some embodiments of the present disclosure. The method described herein utilizes the one-dimensional Nyquist Theorem although formulations for Nyquist Theorem in higher dimensional grids may also be used to determine the maximum allowed spacing between pilots in a 2-dimensional scattered pilots grid. The method described is presented as an example case and is not intended to be shown limiting in any way to the example case described.

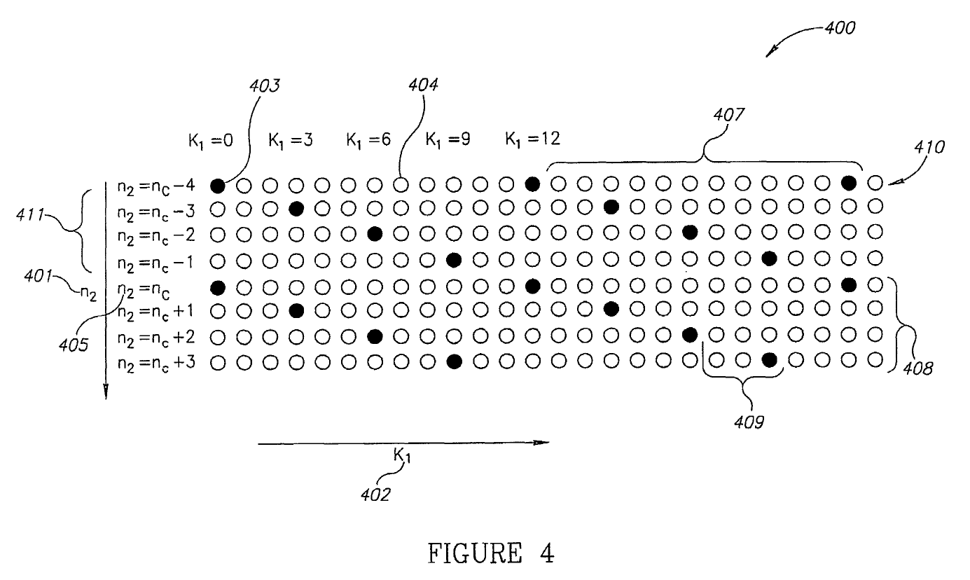

Reference is made to FIG. 3, which is a flow chart showing the steps involved in the method. In the exemplary case the guard interval is assumed to be equal to ¼ of the symbols duration Tsym. Reference is also made to FIG. 4 which shows an exemplary scattered pilots grid (400) which includes frequency carrier bin index k₁ (402), scattered pilots, for example scattered pilot (403), data carriers, for example data carrier (404), scattered pilots spaced three frequency bins, for example three frequency bins (409), OFDM symbols time index n₂ (401), full sets of symbols, for example full set of symbols represented by four consecutive time indexes (411), sets of four SP phases, for example the four SP phases (408) and a SP phase (410), the time index of the currently estimated symbol, n₂=n_{c} (405), scattered pilots spaced twelve carriers apart, for example the twelve carriers (407), which may be similar or the same to that shown in FIG. 2 at (202), (203), (204), (209), (201), (211), (208), (210), (205) and (207), respectively.

Obtain Scattered Pilots Grid (Step 301): Estimate the channel impulse response at the locations of the pilots. The channel is estimated for each OFDM symbol at pilots' locations spaced twelve carriers apart. This spacing is not sufficient, since the maximum allowed spacing for interpolating the channel impulse response to all other carriers is four carriers. Without limiting the to generality of this disclosure, the values of H_{P}(k1,n2) for a scattered pilots grid may be obtained using:

$$Y ( {k}_{1} , {n}_{2} ) = FFT ( y ( {n}_{1} , {n}_{2} ) ) = {\sum }_{n = 0}^{N - 1} y ( {n}_{1} , {n}_{2} ) \cdot {e}^{- j \frac{2 π}{N} {k}_{1} {n}_{2}}$$

$${\hat{H}}_{p} ( {k}_{1} , {n}_{2} ) = \{ \begin{matrix}\frac{Y ( {k}_{1} , {n}_{2} )}{P ( {k}_{1} , {n}_{2} )} & pilot exists at ( {k}_{1} , {n}_{2} ) \\ 0 & no pilot at ( {k}_{1} , {n}_{2} )\end{matrix}$$

where n₂ is the time index of an OFDM symbol, in which a pilot is present in frequency bin k1. At the end of this step, channel estimations are available in carrier locations which are the locations of the scattered pilots. Estimation of the channel impulse response is required for the data carriers in order to reconstruct the data.

Perform Time Interpolation (Step 302): In order to estimate the channel impulse response in the frequency domain for one OFDM symbol, hereinafter referred to as the currently estimated symbol combine the channel impulse response samples available at pilots' locations from at least four consecutive OFDM symbols that also, including the currently estimated symbol, which contain four different SP phases of scattered pilots, to obtain sampled estimations of channel at data carriers locations. Said at least four consecutive OFDM symbols are a full set of symbols. The above process is repeated for each symbol, each time the symbol for which the channel impulse response is estimated is the currently estimated symbol.

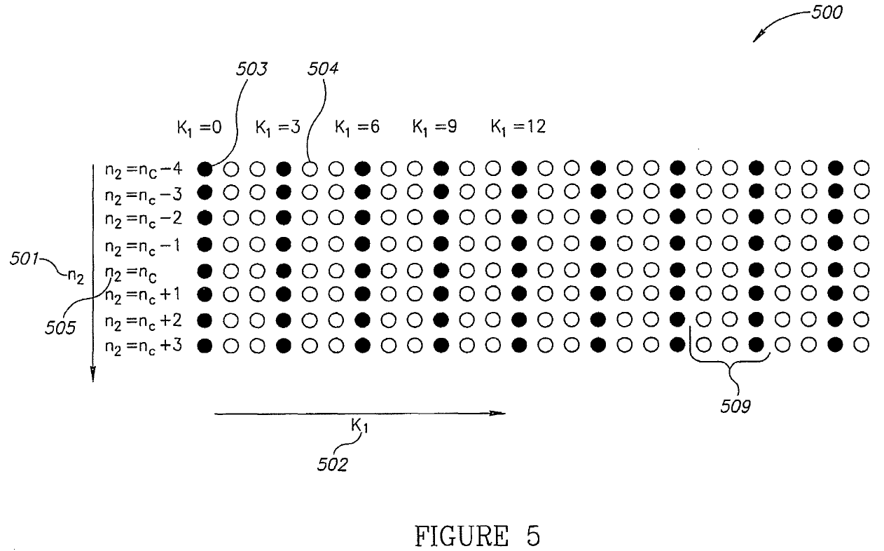

Reference is made to FIG. 5 which shows the scattered pilots grid (500) after performing time interpolation of the channel impulse response samples from the exemplary scattered pilots grid (400). In FIG. 5 the OFDM symbol time index n₂ (501), frequency carrier k₁ (502), pilots for which the channel has been estimated (black circles), for example pilot (503), carriers in which the channel impulse response has not been estimated (white circles), for example carrier (504), OFDM symbols represented by the time indexes of the OFDM symbols, for example time index n₂=n_{c} (505), and pilots spaced three frequency bins apart, for example three frequency bins (509), may be similar or the same to that shown in FIG. 4 at (401), (402), (403), (404), (405), and (509).

At the end of time interpolation step, Step 302, the channel is estimated at all carrier locations containing scattered pilots. The result is that the spacing in the frequency domain between carriers containing pilots and for which the channel impulse response is estimated is 3 frequency bins, smaller than the maximum allowed spacing of 4 frequency bins required by the Nyquist sampling theorem Therefore it is possible to reconstruct the channel impulse response at all frequencies by using frequency interpolation as described in Step 303.

Without limiting to the generality of the present disclosure, time interpolation may be performed using the following linear interpolation equation:

$${\hat{H}}_{time} ( {k}_{1} , {n}_{2} ) = {\sum }_{{d}_{n} = {L}_{1}}^{{L}_{2}} {a}_{m} \cdot \hat{{H}_{p}} ( {k}_{1} , {n}_{2} - {d}_{n} )$$

where L₁ and L₂ are the number of OFDM symbols transmitted before and after the currently estimated OFDM symbol with time index n₂, and are used for time interpolation; αₘ is the weight given during the time interpolation to an OFDM symbol transmitted m OFDM symbols before the current OFDM symbol. The common method requires the use of at least 4 consecutive OFDM symbols in order to have a full set of symbols, so L₂−L₁≧3.

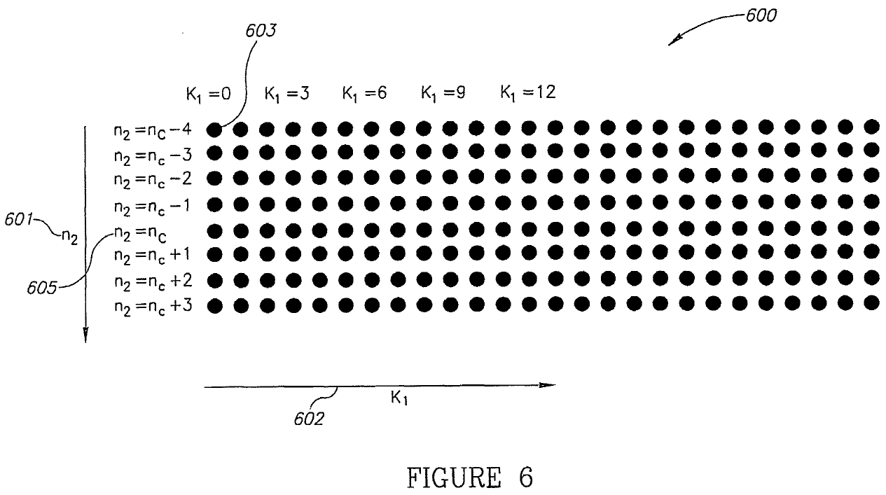

Perform Frequency Interpolation (Step 303): The channel estimations, spaced 3 carriers apart in each OFDM symbol are interpolated in each OFDM symbol in the frequency domain. The result is shown in the scattered pilots grid (600) shown in FIG. 6. Referring to FIG. 6 the OFDM symbol time indexes n₂ (601), frequency carrier k₁ (602), the pilots for which the channel has been estimated (black circles), for example pilot (603) and OFDM symbols represented by the time indexes of the OFDM symbols, for example the currently estimated OFDM symbol time index n₂=n_{c} (605), may be similar or the same to that shown in FIG. 5 at (501), (502), (503), and (505). In FIG. 6 all circles are black, since after frequency interpolation the channel impulse response in the frequency domain is estimated for all carriers (scattered pilots and data carriers).

Without limiting the generality of the present disclosure, frequency interpolation can be performed using the following linear interpolation equation:

$${\hat{H}}_{frequency} ( {k}_{1} , {n}_{2} ) = {\sum }_{m = - {D}_{2}}^{{D}_{2}} {F}_{m} \cdot {H}_{time} ( \tilde{K} , {n}_{2} )$$

$$where$$

$$\tilde{K} = ( {k}_{1} - m ) mod N$$

where Fm are interpolation filter coefficients and D₁ and D₂ are the number of frequency bins in lower and higher frequencies than k₁ used to obtain the interpolation value at frequency bin k₁.

In an embodiment of the present disclosure a method is described which enables the channel impulse response H(k₁,n₂) in all carriers to be estimated with less than the minimum of four OFDM symbols required in a full set of symbols. Additionally, another embodiment of the present disclosure uses the method which enables the estimation of the channel frequency impulse response in all carriers by using an incomplete set of the union of pilots available in a full set of symbols The method includes the identification of one or more situations in which the channel impulse response in the time domain, h(n₁,n₂), occupies a part of the allowed guard interval and not the whole guard interval. A portion, or multiple portions, within the guard interval which contain no energy or a substantially small amount of energy compared to the occupied region may be considered unoccupied regions.

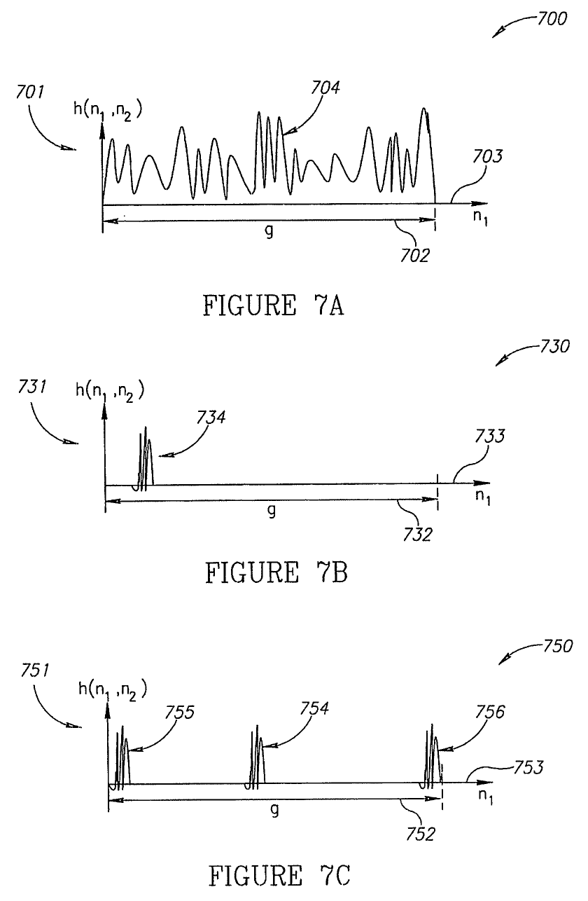

Reference is made to FIGS. 7A, 7B and 7C which are illustrations of various exemplary cases in which the channel impulse response in the time domain, h(n₁,n₂) (704, 734, 754, 755,756), fully occupies or partially occupies a guard interval, g (702, 732, 752) in accordance with an embodiment of the present disclosure. FIGS. 7A, 7B and 7C are in no way intended to limit the described embodiment of the present disclosure to the exemplary cases shown, the exemplary cases shown representing only a fraction of the numerous possible situations which may occur.

FIG. 7A illustrates an exemplary case of a fully occupied guard interval requiring minimum four OFDM symbols to estimate the channel (700). The vertical axis (701) represents the magnitude of the channel impulse response h(n₁,n₂) in the time domain. The horizontal axis (703) represents the channel impulse response time index n₁ within an OFDM symbol which is received at time index n₁, where n₂ is the time index of the OFDM symbol, and n₁ is the time index within an OFDM symbol. The duration of the guard interval is represented by g (702). The waveform (704) represents the channel impulse response in the time domain throughout the entire length of the guard interval (702).

FIG. 7B illustrates an exemplary case of a partially occupied guard interval requiring less than four OFDM symbols to estimate the channel (730). The vertical axis (731) represents the channel impulse response in the time domain. The horizontal axis (733) represents the channel impulse response time index. The duration of the guard interval is represented by g (732). The waveform represents the channel impulse response in the time domain throughout the length of the guard interval (732). The channel impulse response is a narrow energy burst (734) which is concentrated in a time region which occupies only a small portion of a guard interval g.

FIG. 7C illustrates another exemplary case of a partially occupied guard interval requiring less than four OFDM symbols to estimate the channel (750). The vertical axis (751) represents the channel impulse response in the time domain. The horizontal axis (753) represents the channel impulse response time index. The duration of the guard interval is represented by g (752). The channel impulse response is comprised from several narrow energy bursts (754, 755,756) which are concentrated in a time region which occupies only a small portion of a guard interval g.

The Nyquist Theorem may apply to the frequency band which is actually occupied by a signal and not the maximum frequency of a signal. For example, a radio station may generate an AM broadcast by modulating an audio signal with maximum frequency of 10 KHz on a 400 KHz carrier. The transmitted AM signal has a maximum frequency of 410 KHz. Nyquist Theorem does not require the signal to be sampled at a rate of 820 KHz (double-sided frequency band of 410 KHz). Instead, the signal may be sampled, after demodulation, at a rate of 20 KHz, which is the actual double-sided frequency band occupied by the actual transmitted audio signal. A similar concept may be used as a basis for a method for reconstructing the time varying channel frequency impulse response based on using an incomplete set of scattered pilots. The method includes examining the channel impulse response in the time domain and benefiting from situations in which the actual portions of the guard interval which contain a significant amount of channel impulse response energy occupy only part the guard interval. In those situations, channel impulse response can be estimated by using an incomplete set of scattered pilots available in a full set of symbols.

The use of an incomplete set of scattered pilots available in a full set of symbols to reconstruct the channel impulse response in the frequency domain may allow the use of a smaller number of consecutive OFDM symbols to reconstruct the channel, thus allowing greater accurate channel estimation for high Doppler frequencies.

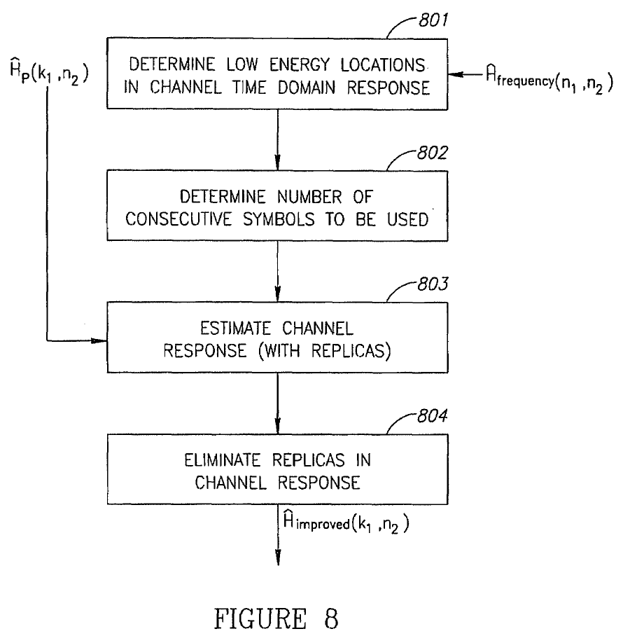

Reference is made to FIG. 8 which is a flow chart showing the steps of the algorithm which may be used to reconstruct the channel impulse response, H(k₁,n₂), based on the use of incomplete sets of the scattered pilots available in a full set of symbols, in accordance with an embodiment of the present disclosure. The steps in the algorithm may be described as follows:

a. Determine the locations of regions with low energy in the guard interval in the channel time domain impulse response Ĥfreq(n₁,n₂) (Step 801). An initial approximate estimation Ĥfreq(n₁,n₂) of the channel impulse response in the time domain can be obtained using the method described by Steps 301, 302, 303 in FIG. 3.

b. Determine the number of consecutive OFDM symbols to be used (Step 802). Generally, the lower the number of OFDM symbols used, the more accurate the channel estimation will be in the presence of fading channel with high Doppler frequencies.

c. Estimate channel impulse response, with replicas, using an incomplete set of scattered pilots obtained from less than four different OFDM symbols (Step 803).

d. Eliminate replicas in the estimation of the channel impulse response in the time domain, using information about the locations of regions with low energy in the guard interval which were obtained in Step 801 (Step 804). At the end of this step, accurate channel impulse response Ĥfreq(k₁,n₂) is obtained.

The following exemplary case illustrates the implementation of the algorithm which may be used to reconstruct the channel impulse response H(k₁,n₂), based on the use of incomplete sets of the scattered pilots available in a full set of symbols. Particularly, the exemplary case illustrates the method by which the channel impulse response, H(k₁,n₂), for each OFDM symbol is estimated based exclusively on the pilots within that single OFDM symbol, and does not rely on scattered pilots within other OFDM symbols.

The exemplary case is in no way intended to limit this embodiment of the present disclosure, so that the method and system described by the exemplary case may be applied to a multiplicity of situations where channel estimation using incomplete sets of scattered pilots may be required. Additionally, this embodiment is not limited to channel estimation based on one OFDM symbol, and in other embodiments of the present disclosure, the channel can also be estimated by using two or more OFDM symbols.

Given a scenario of DVB-H transmission, with parameters as follows:

a Mode=8K;

b. Each OFDM symbol, not including guard interval, lasts for 896 usec;

c. Guard interval=¼, delay spread of the channel may be up to 224 usec;

d. Actual channel model, TU-6 channel with Doppler, and delay spread of 5 usec.

The actual channel has a delay spread of 5 usec, which is far less than the maximum allowed delay spread of 224 usec. Therefore, only a small fraction of the channel impulse response in the time domain actually contains significant energy.

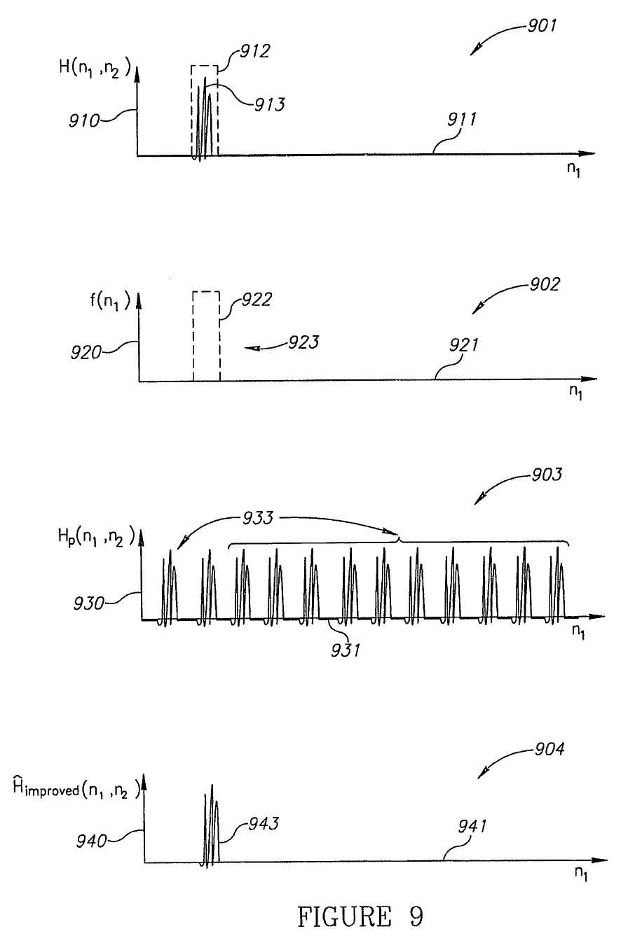

The channel impulse response in the frequency domain while receiving the current OFDM symbol may be estimated by using only the current OFDM symbol, which contains only one SP phase of scattered pilots. Reference is made to FIG. 9 which illustrates graphically in the time domain, the implementation of the method illustrated by FIG. 8, in accordance with an embodiment of the present disclosure. The implementation of the method illustrated in FIG. 9 is described as follows:

a. Determine locations of regions with low energy in guard interval in channel time domain impulse response (901). Obtain an approximate estimate of the magnitude of the channel impulse response H(n₁,n₂), the value represented along the vertical axis (910), in the time domain, represented by the horizontal axis (911), time index n₁. Such an impulse response may be obtained by various methods, including but not limited to, reconstruction of the channel impulse response by using the method previously described for another embodiment of the present disclosure, based on the algorithm described in FIG. 3, which uses four or more consecutive OFDM symbols for estimating the channel impulse response in the time domain.

As a preparation for Step 804 a bandpass filter in the time domain, f(n₁) (923) is prepared to perform interpolation in the time domain (902). The bandpass filter, f(n₁) (923), has a region in the time domain (912, 922) which is designed to pass the energy of the TU-6 channel impulse response (913) and attenuate the time domain regions which do not contain energy of the channel impulse response (911, 921).

The bandpass filter, f(n₁) (923) may be represented in the frequency domain by its Fourier transform:

$$F ( {k}_{1} ) = FFT ( f ( {n}_{1} ) ) = {\sum }_{n = 0}^{N - 1} f ( {n}_{1} ) \cdot {e}^{- j \frac{2 π}{N} {k}_{1} {n}_{1}}$$

The width of the window (912) is made as small as possible, yet large enough to contain the entire TU-6 channel impulse response (913) in the time domain. The bandpass filter, represented in the frequency domain by F(k₁) may by used to filter another signal in the frequency domain by calculating the convolution of the filter and the other signal.

b. Determine the number of consecutive OFDM symbols to be used. The time delay spread of a TU-6 channel is 5 usec, and the time duration of a single OFDM symbol, given the above parameters, is 896 usec excluding the guard interval. Then

$$Δ {K}_{max} = \frac{Tsym}{Tg} = \frac{896}{5} = 179$$

frequency bins
Therefore, even if the channel impulse response in the frequency domain is sampled with spacing of 179 frequency bins it may be fully reconstructed. In a single OFDM symbol, the channel frequency impulse response is sampled by the scattered pilots which are spaced 12 frequency bins apart. Since in this case full channel impulse response reconstruction can be obtained by using channel impulse response estimations which are 179 bins apart, and since each OFDM symbol contains scattered pilots which are only 12 frequency bins apart, then one OFDM symbol is sufficient for full channel impulse response estimation at all frequency bins in that same OFDM symbol.

c. Estimate channel impulse response, with replicas in the time domain by using an incomplete set of scattered pilots obtained from less than four different OFDM symbols (903). This step may be implemented by estimating the channel impulse response of the current OFDM symbol in the frequency domain at the locations of the scattered pilots within the current OFDM symbol, using the equation:

$${\hat{H}}_{p} ( {k}_{1} , {n}_{2} ) = \{ \begin{matrix}\frac{Y ( {k}_{1} , {n}_{2} )}{P ( {k}_{1} , {n}_{2} )} & pilot exists at ( {k}_{1} , {n}_{2} ) \\ 0 & no pilot at ( {k}_{1} , {n}_{2} )\end{matrix}$$

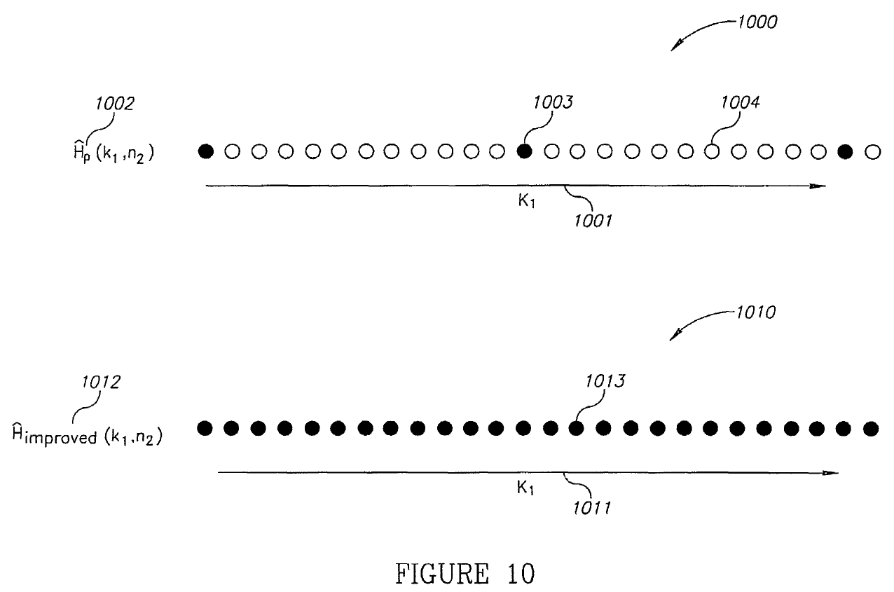

Reference is made to FIG. 10 which illustrates the result of the step in the exemplary case illustrated in FIG. 9, which involves estimating channel impulse response with replicas in the time domain by using an incomplete set of scattered pilots obtained from less than four different OFDM symbols, in accordance with an embodiment of the present disclosure. The step may be represented in the frequency domain by the estimation Ĥ_{P}(k₁,n₂) (1002) of the channel impulse response in the frequency domain (1000), as shown in FIG. 10. The row of circles represents the frequency carriers available in a single OFDM symbol which has been received at time index n₂. The horizontal axis is the frequency bin index k₁ (1001) The black circles, for example black circle (1003), which are separated 12 frequency bins apart, represent the frequency bins within the current OFDM symbol, in which the channel impulse response is available by applying the above formula on the scattered pilots available in that same OFDM symbol The white circles, for example white circle (1004), represent carriers in which an estimation of the channel impulse response is not available at the end of this step, but will be estimated in consecutive steps buy using only the current symbol.

Alternatively, the result of the step can be illustrated in the time domain, as illustrated in FIG. 9 by Ĥ_{P}(n₁,n₂)(930), which is the channel frequency impulse response in the time domain with replicas (903). Note that n₂ is the time index of the entire OFDM symbol while n₁ (931) is the time index of samples within that OFDM symbols.

Ĥ_{P}(n₁,n₂) may be obtained from Ĥ_{P}(k₁,n₂) by applying the Inverse Fast Fourier Transform (IFFT) to Ĥ_{P}(k₁,n₂), such that

$${\hat{H}}_{P} ( {n}_{1} , {n}_{2} ) = IFFT ( {\hat{H}}_{P} ( {k}_{1} , {n}_{2} ) ) \frac{1}{2 π} {\sum }_{{k}_{1} = 0}^{N - 1} {\hat{H}}_{P} ( {k}_{1} , {n}_{2} ) \cdot {e}^{j \frac{2 π}{N} {k}_{1} n}$$

As can be seen the resulting channel impulse response in the time domain with replicas (903) which is available at the end of the step is not identical to the original channel impulse response in the time domain (901) since twelve shifted replicas, for example the shifted replica (933, 934) are obtained of the original channel impulse response (913). The twelve replicas are caused by the estimation of the channel impulse response in the frequency domain only at frequency locations which are separated 12 carrier bins apart, and not at each carrier bin. In order to estimate the original channel impulse response, the replicas of the channel impulse response in the time domain must be filtered out, or equivalently, estimations must be obtained of the channel impulse response in the frequency domain at all frequency carriers and not just in the frequency locations of frequency carriers which are separated 12 frequency bins apart (1000).

d. Eliminate replicas in estimation of the channel impulse response in the time domain (904). Replicas may be eliminated by applying the bandpass filter f(n₁) (923), either in the time domain or in the frequency domain. In the time domain, replicas may be eliminated by multiplying the filter impulse response f(n₁) (920) in the time domain by the channel impulse response h_{P}(n₁,n₂) (930), according to the equation:

ĥ(n₁,n₂)=h_{P}(n₁,n₂)·f(n₁)

Alternatively, in another embodiment of the present disclosure, replicas may be eliminated by filtering in the frequency domain, by convolving the bandpass filter in the frequency domain F(k₁) with the channel impulse response in the frequency domain Ĥ_{P}(k₁,n₂) according to the equation:

$${\hat{H}}_{improved} ( {k}_{1} , {n}_{2} ) = {\sum }_{j = 1}^{N} F ( j ) * {\hat{H}}_{P} ( {k}_{1} - j , {n}_{2} )$$

At the end of the step an estimation Ĥ_{improved}(n₁,n₂)(940) of the channel impulse response in the time domain (904) is obtained which includes the channel impulse response (943), which may be substantially similar or the same as the original channel impulse response (901). The replicas, for example replicas (933, 934) are eliminated in the time domain regions (941).

Equivalently, at the end of this step we have an estimation Ĥ_{improved}(k₁,n₂) (1012) of the channel impulse response in the frequency domain (1010), as illustrated in FIG. 10. All the black circles, for example black circle (1013), represent that the channel impulse response is available at all frequency bins k₁ (101 1) within the current OFDM symbol.

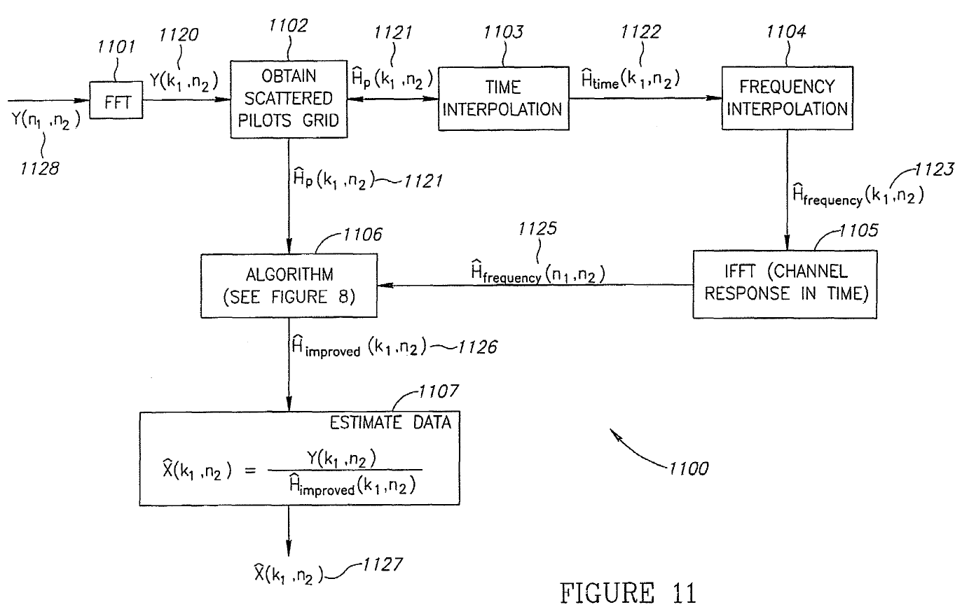

Actual measurements performed demonstrated improvements in modem performance obtained by using the algorithm described above in the presence of fading channel with Doppler frequencies. The following table shows the maximum Doppler frequency, f_{d}, at which a modem can decode the received data with adequate accuracy. A comparison is made of the maximum Doppler frequencies allowed for accurate decoding, based on estimation of the channel impulse response H(k₁,n₂) in the frequency domain, when a full set of symbols is used (four consecutive OFDM symbols) and when only one OFDM symbol is used. The estimation of the channel impulse response H(k₁,n₂) in the frequency domain using a full set of symbols is for an embodiment of the present disclosure based on the method described by the algorithm shown in FIG. 3. The estimation of the channel impulse response H(k₁,n₂) in the frequency domain using only one symbol is for another embodiment of the present disclosure based on the method described by the algorithm shown in FIG. 11.

The experimental parameters conform to the DVB-H standard and are as follows:
Guard interval=¼, Frequency 576 MHz, Mode=8K.
The channel model used was the TU-6 model.
   The results are shown in the following Table:

| | | | f_{d} [Hz] using 4 | f_{d} [Hz] using one |
|---|---|---|---|---|
| Modulation | Code rate | C/N [dB] | symbols | symbol |
| QPSK | ½ | 12.5 | 95 | 173 |
| QPSK | ⅔ | 15.5 | 90 | 134 |
| 16-QAM | ½ | 18.5 | 85 | 115 |

As can be seen from the above table, estimation of the channel impulse response using one symbol enables adequate decoding of the transmitted messages in higher Doppler frequencies than the Doppler frequencies allowed for adequate operation when estimating the channel impulse response using 4 symbols.

Reference is made to FIG. 11, which shows an exemplary simplified functional block diagram of a device for digital channel estimation including channel estimation circuitry (1100), hereinafter referred to as receiver, in accordance with an embodiment of the present disclosure.

The receiver (1100) receives a block of OFDM symbols y(n₁,n₂) (1128) which may have experienced channel fading and other possible channel distortions Each received OFDM symbol y(n₁, n₂) (1128) undergoes FFT (1101) where it is converted into the frequency domain, resulting in the symbol's representation in the frequency domain Y(k₁,n₂) (1120). A scattered pilots grid is then obtained (1102) by estimating the channel impulse response, Ĥ_{P}(k₁,n₂) (1121) at the location of the scattered pilots. This channel impulse response Ĥ_{P}(k₁,n₂) (1121) serves as one of the inputs required by the algorithm function (1106).

The second input required by the algorithm function (1106) is the channel frequency impulse response in the time domain, Ĥ_{frequency}(n₁,n₂) (1125), which is required to be accurate enough to detect regions in the channel impulse response in the time domain which are not occupied with substantial energy. In order to determine the channel frequency impulse response in the time domain, Ĥ_{frequency}(n₁,n₂) (1125), from the channel frequency impulse response at the pilots' locations, Ĥ_{P}(k₁,n₂) (1121), time and frequency interpolation are performed. The channel impulse response Ĥ_{P}(k₁,n₂)(1121) is subject to time interpolation (1103) by combining the channel impulse response samples at pilot locations from four consecutive OFDM symbols as illustrated in FIG. 3, to obtain Ĥₜᵢₘₑ(k₁,n₂) (1122). Frequency interpolation (1104) is performed on the channel impulse response Ĥₜᵢₘₑ(k₁,n₂) (1122) in the frequency domain, as illustrated in FIG. 3, to obtain the channel impulse response Ĥ_{frequency}(k₁,n₂) (1123) in the frequency domain. The channel impulse response in the frequency domain Ĥ_{frequency}(k₁,n₂) (1123) undergoes an IFFT (1105) so as to obtain Ĥ_{frequency}(n₁,n₂) (1125) which is in the time domain and serves as the second input required by the algorithm function (1106).

The output of the algorithm function (1106) is a more accurate (or improved) channel impulse response Ĥ_{improved}(k₁,n₂) (1126) in the frequency domain. The improved estimation of the channel impulse response Ĥ_{improved}(k₁,n₂) (1126) serves an input for the data estimation block (1107) in which an estimation of the original OFDM symbol \hat{X}(k₁,n₂)(1127) is obtained. The role of the data estimation block is to reduce as much as possible distortions caused to the transmitted data \hat{X}(k₁,n₂)(1127) by the channel, by using the improved estimation channel impulse response in the frequency domain, Ĥ_{improved}(k₁,n₂) (1126).

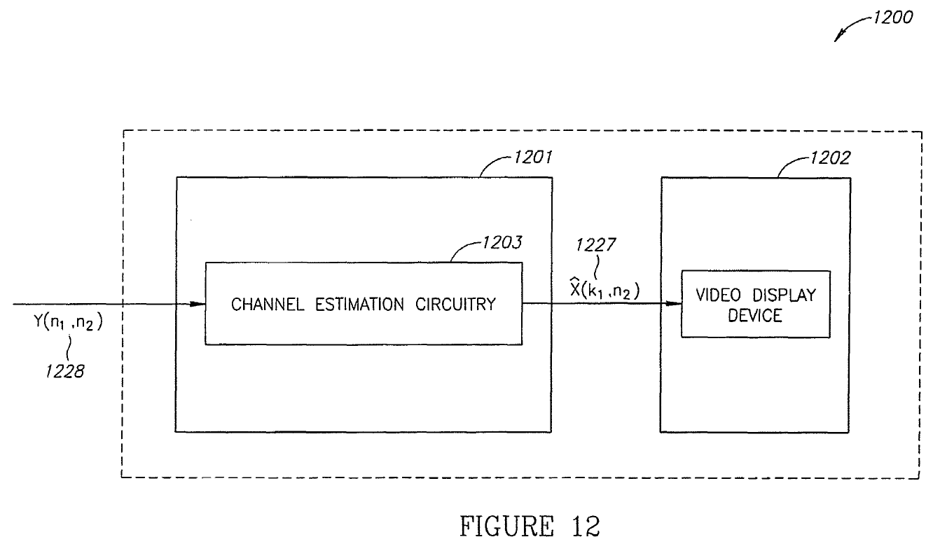

Reference is made to FIG. 12 which schematically shows an exemplary conceptual block diagram of a system 1200 including a receiver 1201, which may be the similar or the same to that shown in FIG. 11 at 1100, and a video display device 1202, in accordance with an embodiment of the present disclosure. System 1200 may include any fixed and/or mobile and/or portable system in which may be adapted receiver 1001, for example portable computers, indoor and/or outdoor use equipment incorporating electronic devices, handheld communications systems, vehicles, and others.

The receiver (1201) in system (1200) receives a block of OFDM symbols y(n₁,n₂) (1228), which may be the same or similar to that shown in FIG. 11 at (1128), which may have experienced channel fading and other possible channel distortions. The block of OFDM symbols (1228) is processed by a channel estimation circuitry (1203) in the receiver (1201) so that at the output of receiver (1201) is obtained \hat{X}(k₁,n₂)(1227), which may be similar to that shown in FIG. 11 at (1127). The obtained output \hat{X}(k₁,n₂) (1227) is then input to the video display device (1202) in the system (1200) where the data is processed and displayed for viewing.

While a number of exemplary aspects and embodiments have been discussed above those of skill in the art will recognize certain modifications, permutations, additions and sub-combinations thereof. It is therefore intended that the following appended claims and claims hereafter introduced be interpreted to include all such modifications, permutations, additions and sub-combinations as are within their true spirit and scope.

What we claim is:

1. A method of estimating a channel impulse response comprising using an incomplete set of orthogonal frequency division multiplexing (OFDM) symbols to estimate said impulse response.

2. The method of claim 1, wherein at least one of the OFDM symbols comprises a scattered pilot.

3. The method of claim 1, wherein the full set of OFDM symbols comprises 4 OFDM symbols.

4. The method of claim 2, wherein each OFDM symbol within the full set of OFDM symbols is associated with a different SP phase.

5. The method of claim 1, wherein the incomplete set of OFDM symbols comprises 3 symbols.

6. The method of claim 1, wherein the incomplete set of OFDM symbols comprises 2 symbols.

7. The method of claim 1, wherein the incomplete set of OFDM symbols comprises 1 symbol.

8. The method of claim 1, wherein estimating the channel impulse response further comprises:
Determining a first channel estimation value based on the full set of received OFDM symbols; and
Determining a second channel estimation based on the first channel estimation value or an incomplete set of the first of received OFDM symbols and on a second set of received OFDM symbols, wherein the second set of received OFDM symbols is an incomplete set of OFDM symbols.

9. The method of claim 1, further comprising determining where the channel impulse response in the time domain occupies a portion of the allowed guard interval.

10. The method of claim 9 further comprising identifying at least one region of relatively distinct energy level within the channel impulse response in the time domain.

11. The method of claim 1, further comprising estimating a channel impulse response using an incomplete set of scattered pilots.

12. The method according to claim 11, further comprising eliminating time domain replicas in channel estimation caused partially or fully due to the use of an incomplete set of scattered pilots instead of the full set of scattered pilots.

13. The method according to claim 12, wherein locations of replicas and the original channel impulse response in the time domain are determined by using said at least one region of relatively distinct energy and are used to eliminate said replicas.

14. The method according to claim 12, wherein eliminating time domain replicas in the estimation of the channel impulse response is performed in the frequency domain by convolving the channel impulse response in the frequency domain, which contains replicas in the time domain with a filter which attenuate the replicas relative to the correct channel impulse response.

15. The method according to claim 12, wherein eliminating time domain replicas in the estimation of the channel impulse response is performed in the time domain by multiplying the channel impulse response in the time domain, which contains replicas in the time domain with a bandpass filter which attenuate the replicas relative to the correct channel impulse response.

16. The method according to claim 14 wherein said filter is determined partially or fully by using said at least one region of relatively distinct energy.

17. The method according to claim 15 wherein said bandpass filter is determined partially or fully by using said at least one region of relatively distinct energy.

18. A device for digital video channel estimation comprising:
a channel estimation circuitry adapted to estimate a channel impulse response using an incomplete set of orthogonal frequency division multiplexing (OFDM) symbols to estimate said impulse response.

19. The device of claim 18, wherein at least one of the OFDM symbols comprises a scattered pilot.

20. The device of claim 18, wherein the full set of OFDM symbols comprises 4 OFDM symbols.

21. The device of claim 19, wherein each OFDM symbol within the full set of OFDM symbols is associated with a different SP phase.

22. The device of claim 18, wherein the incomplete set of OFDM symbols comprises 3 symbols.

23. The device of claim 18, wherein the incomplete set of OFDM symbols comprises 2 symbols.

24. The device of claim 18 wherein the incomplete set of OFDM symbols comprises 1 symbol.

25. The device of claim 18, wherein said channel estimating circuitry is further adapted to estimate the channel impulse by determining a first channel estimation value based on full set of received OFDM symbols;
and by determining a second channel estimation based on the first channel estimation value or an incomplete set of the first of received set of OFDM symbols and on a second set of received OFDM symbols, wherein the second set of received OFDM symbols is an incomplete set of OFDM symbols.

26. The device of claim 18, where said channel estimating circuitry is further adapted to determine where the channel impulse response in the time domain occupies a portion of the allowed guard interval.

27. The device of claim 26, where said estimating circuitry is further adapted to further identify at least one region of relatively distinct energy level within the channel impulse response in the time domain.

28. The device of claim 18, where said channel estimating circuitry is further adapted to estimate a channel impulse response using an incomplete set of scattered pilots.

29. The device of claim 28, where said channel estimating circuitry is further adapted to eliminate time domain replicas in channel estimation caused partially or fully due to the use of an incomplete set of scattered pilots instead of the full set of scattered pilots.

30. The device of claim 29 wherein locations of replicas and the original channel impulse response in the time domain are determined by using said at least one region of relatively distinct energy and are used to eliminate said replicas.

31. The device of claim 29, wherein eliminating time domain replicas in the estimation of the channel impulse response is performed in the frequency domain by convolving the channel impulse response in the frequency domain, which contains replicas in the time domain with a filter which attenuate the replicas relative to the correct channel impulse response.

32. The device of claim 29, wherein eliminating time domain replicas in the estimation of the channel impulse response is performed in the time domain by multiplying the channel impulse response in the time domain, which contains replicas in the time domain with a bandpass filter which attenuate the replicas relative to the correct channel impulse response.

33. The device according to claim 31, wherein said filter is determined partially or fully by using said at least one region of relatively distinct energy.

34. The device according to claim 32, wherein said bandpass filter is determined partially or fully by using said at least one region of relatively distinct energy.

35. A system for digital video receiving comprising:
a video display device and;
a device for digital video channel estimation comprising channel estimation circuitry adapted to estimate a channel impulse response using an incomplete set of received orthogonal frequency division multiplexing (OFDM) symbols to estimate said impulse response.

36. The system of claim 35, wherein at least one of the OFDM symbols comprises a scattered pilot.

37. The system of claim 35, wherein the full set of OFDM symbols comprises 4 OFDM symbols.

38. The system of claim 36, wherein each OFDM symbol within the full set of OFDM symbols is associated with a different SP phase.

39. The system of claim 35, wherein the incomplete set of OFDM symbols comprises 3 symbols.

40. The system of claim 35, wherein the incomplete set of OFDM symbols comprises 2 symbols.

41. The system of claim 35, wherein the incomplete set of OFDM symbols comprises 1 symbol.

42. The system of claim 35, wherein said channel estimating circuitry is further adapted to estimate the channel impulse by determining a first channel estimation value based on full set of received OFDM symbols;
and by determining a second channel estimation based on the first channel estimation value or an incomplete set of the first of received OFDM symbols and on a second set of received OFDM symbols, wherein the second set of received OFDM symbols is an incomplete set of received OFDM symbols

43. The system of claim 42, where said channel estimating circuitry is further adapted to determine where the channel impulse response in the time domain occupies a portion of the allowed guard interval.

44. The system of claim 43, where said channel estimating circuitry is further adapted to further identify at least one region of relatively distinct energy level within the channel impulse response in the time domain.

45. The system of claim 35, where said channel estimating circuitry is further adapted to estimate a channel impulse response using an incomplete set of scattered pilots.

46. The system of claim 45, where said channel estimating circuitry is further adapted to eliminate time domain replicas in channel estimation caused partially or fully due to the use of an incomplete set of scattered pilots instead of the full set of scattered pilots.

47. The system of claim 46 wherein locations of replicas and the original channel impulse response in the time domain are determined by using said at least one region of relatively distinct energy and are used to eliminate said replicas.

48. The system of claim 46, wherein eliminating time domain replicas in the estimation of the channel impulse response is performed in the frequency domain by convolving the channel impulse response in the frequency domain, which contains replicas in the time domain with a filter which attenuate the replicas relative to the correct channel impulse response.

49. The system of claim 46, wherein eliminating time domain replicas in the estimation of the channel impulse response is performed in the time domain by multiplying the channel impulse response in the time domain, which contains replicas in the time domain with a bandpass filter which attenuate the replicas relative to the correct channel impulse response.

50. The system according to claim 48, wherein said filter is determined partially or fully by using said at least one region of relatively distinct energy.

51. The system according to claim 49, wherein said bandpass filter is determined partially or fully by using said at least one region of relatively distinct energy.
